(19) United States
(12) Patent Application Publication
(10) Pub. No.: US 2017/0153909 A1
(43) Pub. Date: Jun. 1, 2017

(54) Methods and Devices for Acquiring Data Using Virtual Machine and Host Machine

(71) Applicant: Alibaba Group Holding Limited, Grand Cayman (KY)

(72) Inventors: Xiantao Zhang, Hangzhou (CN); Yibin Shen, Hangzhou (CN)

(21) Appl. No.: 15/364,086

(22) Filed: Nov. 29, 2016

(30) Foreign Application Priority Data
Nov. 30, 2015 (CN) 201510857127.X

(51) Int. Cl. G06F 9/455; H04L 29/08

(52) U.S. Cl. CPC G06F 9/45558; H04L 67/10; G06F 2009/45579

(57) ABSTRACT

A method of acquiring data using a virtual machine, a method of acquiring data using a host machine, a system for accessing cloud data, and an electronic device thereof. The method of acquiring data using a virtual machine may include acquiring directory information of files that is stored in a cloud server. The virtual machine may further receive a selection operation of the files that is shown in the directory information and generate an acquisition request for data corresponding to the selection operation in the files. Further, the virtual machine may place the request in the buffer and receive return data corresponding to the selection operation from a host machine. In some implementations, the host machine may download data requested by the virtual machine and then provide the data to the virtual machine by sharing memory with the virtual machine.

### CROSS REFERENCE TO RELATED PATENT APPLICATIONS

This application claims priority to Chinese Patent Application No. 201510857127.X, filed on Nov. 30, 2015, entitled “Methods and Devices for Acquiring Data Using Virtual Machine and Host Machine as Well as Systems for Accessing Data Thereof,” which is hereby incorporated by reference in its entirety.

### TECHNICAL FIELD

The present disclosure relates to the field of communication technology, and particularly to a method of acquiring data using a virtual machine, a method of acquiring data using a host machine, a system for accessing cloud data, and an electronic device thereof.

### BACKGROUND

A virtual machine is a software simulation system associated with peripheral devices or applications. In a current virtual machine environment, a host operating system obtains client information on a virtual machine via web service techniques, for example, Hypertext Transfer Protocol (HTTP), file transfer servers (FTP) or network drive machines (NFS, CIFS).

With the rapid development of cloud platform technology and mobile terminal products, open storage services have emerged to synchronize files at various terminals. In addition to uploading local files to cloud servers, open storage services mainly acquire files from the cloud servers and read them locally. When a virtual machine uses an open storage service, the virtual machine generally has to download files to a local storage. Because virtual machines have traffic restrictions, the virtual machines consume traffic when accessing data on the open storage service.

Thus, under current techniques, virtual machines consume traffic when accessing data on the open storage service. For example, a file on the open storage service has a large amount of data. In these instances, while only a part of the data is needed, a virtual machine will have downloaded the whole file before using it. Therefore, the virtual machine consumes a large amount of traffic.

### SUMMARY

The present disclosure relates to a method of acquiring data using a virtual machine, a method of acquiring data using a host machine, and a system for accessing cloud data. Implementations of the present disclosure solve problems of current techniques, which consume too much traffic to access cloud data by virtual machines. The present disclosure further relates to a device for acquiring data using a virtual machine and an electronic device thereof as well as a device for acquiring data using a host machine and an electronic device thereof. This Summary is not intended to identify all key features or essential features of the claimed subject matter, nor is it intended to be used alone as an aid in determining the scope of the claimed subject matter.

The present disclosure further relates to a method of acquiring data using a virtual machine. The method may include acquiring directory information of files that is stored in a cloud server. The virtual machine may receive a selection operation of the files that is shown in the directory information, generate an acquisition request for data corresponding to the selection operation in the files, place the acquisition request in a buffer, and then receive return data corresponding to the selection operation from a host machine.

The present disclosure further relates to a device for acquiring data using a virtual machine. The device may include a directory information acquisition module configured to acquire directory information of files that is stored in a cloud server, a selection operation receiving module configured to receive a selection operation of the files that is shown in the directory information, a request generation module configured to generate an acquisition request for data corresponding to the selection operation in the files, a request transmitting module configured to place the acquisition request in a buffer, and a data receiving module configured to receive the return data corresponding to the selection operation from a host machine.

In addition, the implementations further relate to an electronic device. The electronic device may include a display, one or more processors, and memory configured to store instructions to acquire data using a virtual machine, when the instructions are processed by the one or more processors, to perform the following operations. The operations may include acquiring directory information of files that is stored in a cloud server, receiving a selection operation of the files that is shown in the directory information, generating an acquisition request for data corresponding to the selection operation in the files, placing the acquisition request in a buffer, and receiving return data corresponding to the selection operation from a host machine.

In addition, the present disclosure further relates to a method of acquiring data using a host machine. The method may include acquiring a request for data corresponding to a selection operation in files, the data stored in a buffer by a virtual machine, acquiring the data corresponding to the selection operation based on the request, and transmitting the data corresponding to the selection operation to the virtual machine.

The present disclosure further relates to a device of acquiring data using a host machine. The device may include a request acquisition module configured to acquire a request for data corresponding to a selection operation in files, a data acquisition module configured to acquire the data corresponding to the selection operation based on the request, and a data return module configured to transmit the data corresponding to the selection operation to the virtual machine. The data is stored in a buffer by a virtual machine

In addition, the implementations further relate to an electronic device. The electronic device may include a display, one or more processors, and memory configured to store instructions to acquire data using a host machine, when the instructions are processed by the one or more processors, to perform the following operations. The operations may include acquiring a request for data corresponding to a selection operation in files, acquiring the data corresponding to the selection operation based on the request, and transmitting the data corresponding to the selection operation to the virtual machine. The data is stored in a buffer by a virtual machine

In addition, the present disclosure further relates to a system for accessing cloud data using a virtual machine. The system may include a device for acquiring data using the virtual machine as described above, and a device for acquiring data using the host machine as described above.

The implementations herein relate to methods and devices for acquiring data. The implementations include acquiring directory information of files that is stored in a cloud server, receiving a selection operation of the files that is shown in the directory information, generating an acquisition request for data corresponding to the selection operation in the files, placing the acquisition request in a buffer, and receiving return data corresponding to the selection operation from a host machine.

The implementations of the present disclosure further relate to a method of acquiring data using a host machine as well as a device and an electronic device thereof. The implementations may include acquiring a request for data corresponding to a selection operation in files, acquiring the data corresponding to the selection operation based on the request, and transmitting the data corresponding to the selection operation to the virtual machine. The data is stored in a buffer by a virtual machine

Compared with conventional techniques, implementations of the present disclosure have the following advantages. For example, the conventional techniques need to complete downloading of a data before the data is used while accessing cloud data. In implementations, a host machine may download data requested by a virtual machine, and further provides the data to the virtual machine by sharing memory with the virtual machine. Therefore, traffic during accessing of cloud data may be consumed efficiently.

### BRIEF DESCRIPTION OF THE DRAWINGS

The Detailed Description is described with reference to the accompanying figures. The use of the same reference numbers in different figures indicates similar or identical items.

FIG. 1 is a flowchart illustrating a process of acquiring data using a virtual machine in accordance with the implementations of the present disclosure.

FIG. 2 is a flowchart illustrating a process of creation of a virtual disk device in accordance with the implementations of the present disclosure.

FIG. 3 is a flowchart illustrating acquiring directory information of files that is stored in a cloud server in accordance with the implementation of the present disclosure.

FIG. 4 is a flowchart illustrating a process of receiving a selection operation of the files that is shown in the directory information in accordance with the implementations of the present disclosure.

FIG. 5 is a flowchart illustrating a process of receiving return data corresponding to a selection operation from a host machine in accordance with the implementations of the present disclosure.

FIG. 6 is a schematic diagram illustrating a device for acquiring data using a virtual machine in accordance with the implementations of the present disclosure.

FIG. 7 is a schematic diagram illustrating an electronic device.

FIG. 8 is a flowchart illustrating a process of acquiring data using a host machine in accordance with the implementations of the present disclosure.

FIG. 9 is a flowchart illustrating acquiring the data corresponding to a selection operation based on the request in accordance with the implementations of the present disclosure.

FIG. 10 is a flowchart illustrating a process transmitting data corresponding to a selection operation to a virtual machine in accordance with the implementations of the present disclosure.

FIG. 11 is a schematic diagram illustrating a device for acquiring data using a host machine in accordance with the implementations of the present disclosure.

FIG. 12 is a schematic diagram illustrating a system for accessing cloud data using a virtual machine in accordance with the implementations of the present disclosure.

FIG. 13 is another schematic diagram illustrating a system for accessing cloud data using a virtual machine in accordance with the implementations of the present disclosure.

### DETAILED DESCRIPTION

The detailed description is described with reference to the accompanying figures. Below, in conjunction with the accompanying figures, implementations of the present disclosure are described. In addition, in the following description, numerous specific details are set forth in order to fully understand the present disclosure. However, the present disclosure can be implemented in many other ways than those described herein. Those skilled in the art can make similar improvement without departing from the present disclosure. Accordingly, this application is therefore not limited in the specific implementations disclosed below.

The present disclosure relates to a method of acquiring data using a virtual machine, a method of acquiring data using a host machine, a system for accessing cloud data, and an electronic device thereof. Below provided detailed implementations.

Currently, when a virtual machine uses an open storage service, the virtual machine generally has to download files to a local storage. Because virtual machines have traffic restrictions, data access on the open storage service consumes traffic of the virtual machines. Thus, accessing data on an open storage service using conventional techniques consumes traffic of virtual machines. In conventional techniques when a file on the open storage service has a large amount of data, but only a part of the data is needed, the virtual machines download the whole file. Therefore, the virtual machines consume a large amount of traffic. To solve this problem, the implementations herein acquire directory information of files that is stored in a cloud server, receive a selection operation of the files that is shown in the directory information, and receive the return data corresponding to the selection operation from a host machine. The implementations may acquire data based on the demand without consuming additional traffic of the virtual machines.

To facilitate understanding of technical solutions provided herein, the first aspect of the present disclosure is provided with a brief description before describing the detailed implementations.

Implementations enable a virtual machine to access cloud data without consuming additional traffic. In other words, a host machine cooperates with a virtual machine to access the cloud data.

A virtual Machine refers to software simulation of a complete hardware system functions that run in a completely isolated environment of a computer system. A virtual system generates a new virtual image of the existing operating system to have functions of an operating system such as Windows. Entering the virtual system, all operations are inside of this new independent virtual system, and software can be installed and run independently. For example, the system may save data, have its own independent desktop, and have no impact on the real system. The virtual system has flexibility to switch between the existing system and a virtual mirror-like operating system.

A host machine is the physical basis of a virtual machine, and the virtual machine exists in the host machine. The virtual machine and the host machine share the hardware. Operations of the host machine are the basis of operations of the virtual machine. For example, a virtual machine is installed on a host machine, and is operable after the host machine runs. A host machine is a host.

Open Storage Service (OSS) is a cloud storage service. Using OSS, data uploading and downloading can be implemented via a simple REST interface at any time and any place. OSS also enables WEB page data management. OSS further enables building of a variety of media-sharing sites, network disks, personal enterprise data backup, and other large-scale data-based services, as described in more detailed below.

The present disclosure further relates to a method of acquiring data using a virtual machine. Implementations of the method are provided below.

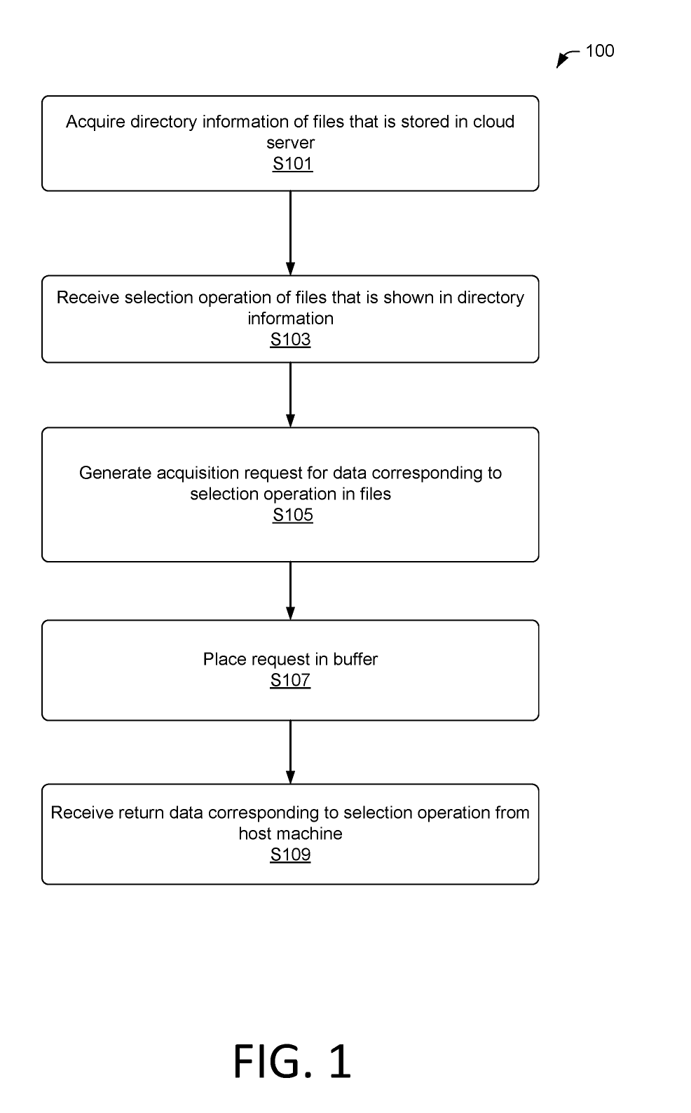

FIG. 1 is a flowchart illustrating a process 100 of acquiring data using a virtual machine in accordance with the implementations of the present disclosure.

The method for acquiring data using a virtual machine may include the following operations.

At S101, the virtual machine may acquire directory information of files that is stored in a cloud server.

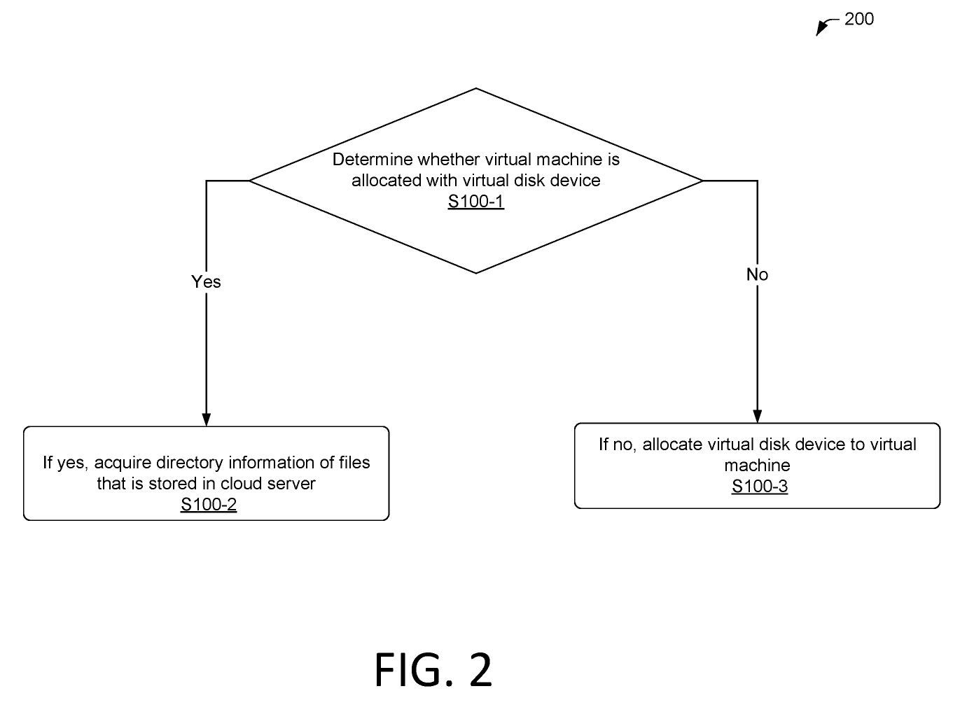

Prior to acquiring the directory information of the files that is stored in the cloud server, the virtual machine may allocate the virtual disk device to the virtual machine. Detailed operations are provided at S100-1 to S100-3 in FIG. 2.

FIG. 2 is a flowchart illustrating a process 200 of creation of virtual disk device in accordance with the implementations of the present disclosure.

At S100-1, the virtual machine may determine whether the virtual machine is allocated with a virtual disk device. In implementations, the allocated virtual disk device may include a virtual disk device on a bus of the virtual machine.

At S100-2, if the virtual machine is allocated with a virtual disk device, the virtual machine may acquire the directory information of the files that is stored in the cloud server at S101.

At S100-3, if the virtual machine is not allocated with a virtual disk device, the virtual machine may allocate the virtual disk device to the virtual machine.

It should be noted that data access to a bus of the virtual machine may be implemented by an internal driver of the virtual machine. Management, configuration, and transfer of read and write requests of the virtual disk device may be implemented by calling a device interface of the virtual disk device. The device interface allows the virtual machine to access a virtual storage space in accordance with the manner of accessing a disk device. After receiving a read and write request from the virtual machine, the virtual disk device may not process the requests but forward the requests to an underlying character device.

After the virtual machine detects that the bus of the virtual machine is loaded with the virtual disk device, the virtual machine may be added to a character device. The character device is a device operated using a character stream mode, and operating units are characters.

It should be noted that the virtual machine is mounted in a device (such as a block or character) on the host machine. When the virtual machine sends a data input/output (I/O) request for performing input/output (I/O) operations on the data on the virtual machine, the character device is connected to a corresponding storage system. For example, for a user state process on a physical machine to which I/O requests of the virtual machine are sent, the user state process may include a location of the sector of the virtual disk device of the virtual machine and a corresponding user state storage system connected to a storage system interface to which the I/O requests are sent. The I/O requests may be provided by a certain sector of the virtual disk device of the virtual machine.

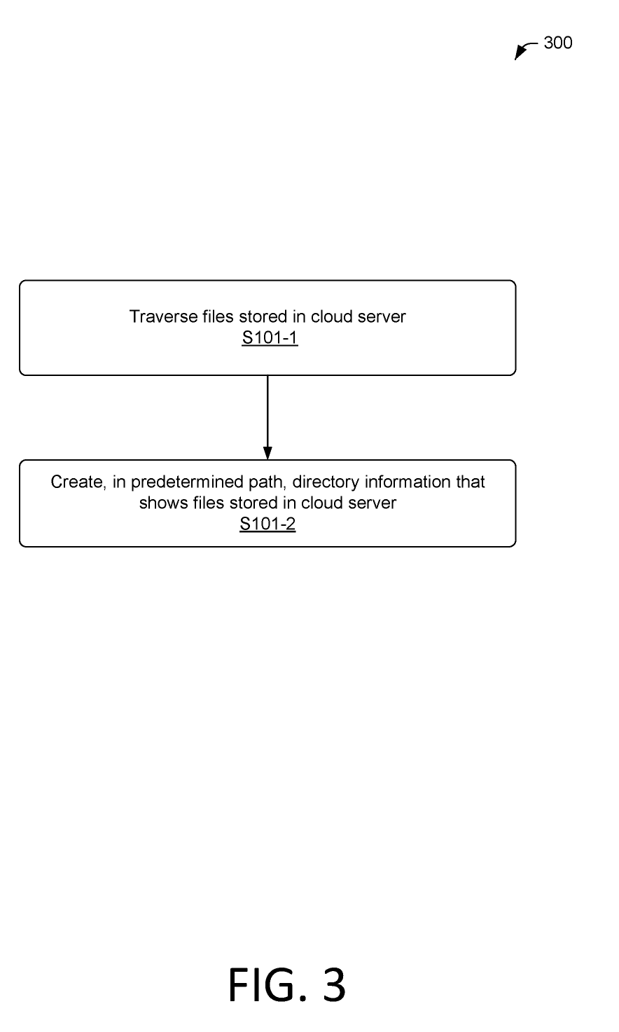

In implementations, after the host machine establishes a connection with the OSS server based on user account information, the virtual machine traverses the files stored in the cloud server. The directory information may be shown in the virtual machine. Detailed operations are provided in S101-1 to S101-2, as illustrated in FIG. 3.

FIG. 3 is a flowchart illustrating a process 300 of acquiring directory information of files that is stored in a cloud server in accordance with the implementation of the present disclosure.

At S101-1, the virtual machine may traverse the files stored in the cloud server.

In implementations, the virtual machine traverses the files stored in the cloud server in the following manners. The user state process of the virtual machine may load a character device via an I/O management function to traverse the files stored in the OSS to obtain a list of the traversed file and obtain identification information of the traversed file. The identification information may include: a corresponding file name, file type, and file path.

It should be noted that a folder is called a bucket, and a file stored in the bucket is referred to as an object in the OSS. The virtual machine may traverse objects in all the buckets and obtain identification information of the traversed objects.

In implementations, the list of the traversed files may be obtained by calling list_objects (bucket_name). After obtaining the list of the objects in the buckets, head_object (bucket_name, object_name) may be called to obtain the identification information.

At S101-2, the virtual machine may create, in a predetermined path, the directory information that shows the files stored in the cloud server.

In implementations, the virtual machine may create, in a predetermined path, the directory information that shows the files stored in the cloud server in the following manners. The virtual machine may create a folder having the same name of the bucket under a certain folder. The folder contains the corresponding directory information of objects stored in the OSS. The directory information is a list of identification information of the objects stored in the OSS.

At S103, the virtual machine may receive a selection operation of the files that is shown in the directory information.

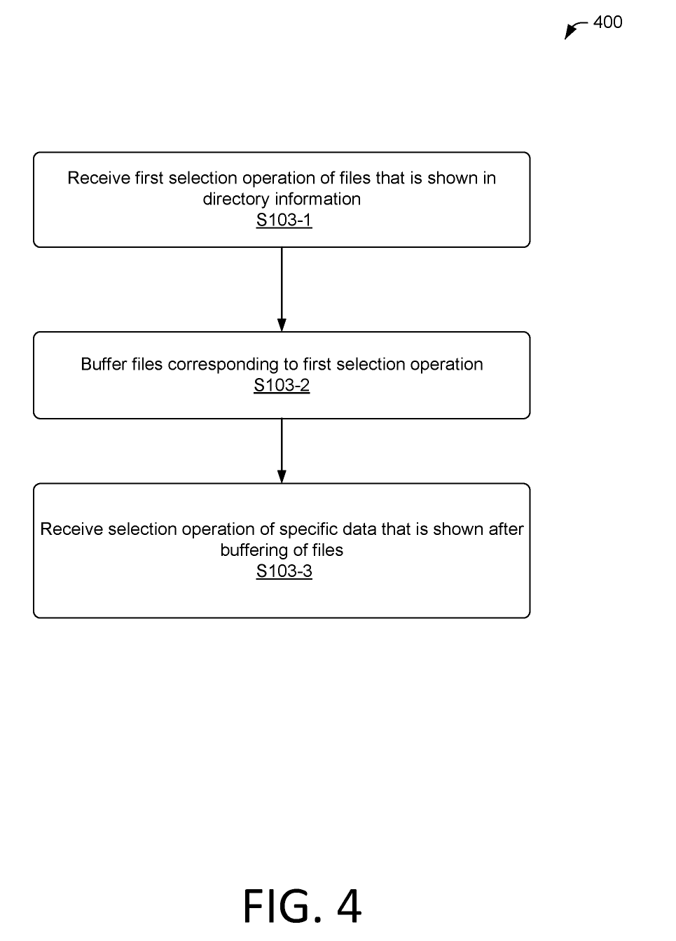

In implementations, the received selection operation of the files is a selection operation on the directory information of the files stored in the cloud server. The selection operation has been received in operation S101 and shown in the specific file. Detailed operations are provided in S103-1 to S103-3, as illustrated in FIG. 4

FIG. 4 is a flowchart illustrating a process 400 of receiving a selection operation of the files that is shown in the directory information in accordance with the implementations of the present disclosure.

At S103-1, the virtual machine may receive a first selection operation of the files that is shown in the directory information.

In implementations, the receiving the selection operation of the files that is shown in the directory information in the following manners. For example, the virtual machine may receive a selection operation including a single-click or a double-click of a user on an object shown in the directory information.

It should be noted that the first selection operation shown in the directory information of files refers to the single-click or the double-click on the object shown in the directory information. It is understood that the directory information of files that is stored in the cloud server and acquired at S101 is the mapping of the corresponding object in the OSS. The directory information includes a name, a file path, and a file type of the object, while not containing data of the object.

At S103-2, the virtual machine may buffer files corresponding to the first selection operation.

This operation is the first selection operation on the file shown in the directory information received at S103-1, and the buffered files correspond to the first selection operation.

The virtual machine may buffer files corresponding to the first selection operation in the following manners. According to the first selection operation, the virtual machine obtains a temporary cache file of the corresponding object.

For example, the file of the first selection operation is a video file, the buffer loads the video file, and a progress bar is shown to indicate progress of buffered data.

At S103-3, the virtual machine may receive a selection operation of specific data that is shown after the buffering of the files.

In implementations, the virtual machine may receive a selection operation of specific data shown in response to the buffering of the files in the following manners. A display screen of the virtual machine may show the specific data of the object after buffering, and the virtual machine may receive a selection operation from a user via a mouse-click on the specific data. The selection operation on the specific data may include selection of the specific data of the file or a location of the specific data.

For example, the file is a database file, which includes 5 data pieces. The virtual machine may show the 5 data pieces after buffering, and receive a selection operation on the second and third data pieces in the database file. In implementations, the file is a video file, and the length of the video file is 50 minutes. The virtual machine may receive a selection operation on a location of a progress bar (e.g., 20 minutes to 22 minutes) of the video file.

At S105, the virtual machine may generate an acquisition request for data corresponding to the selection operation in the files.

In these instances, the virtual machine may generate an acquisition request for data corresponding to the selection operation in the files based on the selection operation of files that is shown in the directory information and received at S103. The virtual machine may generate the acquisition request for the data corresponding to the selection operation in the files in the following manners. The virtual machine may acquire the request of the data corresponding to the selection operation in the object based on the selection operation of the specific data that is shown after buffering the object.

It should be noted that the acquisition request may include a path of the files and a location corresponding to the data corresponding to the selection operation. It is understood that the virtual machine may place path information of the object in the OSS corresponding to the selection operation and the location of the specific data of the object corresponding to the selection operation into the request.

At S107, the virtual machine may place the request in the buffer.

The operation places the request of data corresponding to the selection operation of files that is acquired at S105 in the buffer.

The buffer is an area for temporary storage of data in memory when the computer reads data, and is memory temporarily storing output or input data. The data is then sent to the CPU or other computing devices.

To allow the host machine to acquire the data corresponding to the selection operation of files as early as possible, the present disclosure provides further implementations. In some implementations, the virtual machine places the request of data corresponding to the selection operation in the buffer, and then sends a prompt message of the acquisition request to the host machine.

At S109, the virtual machine may receive return data corresponding to the selection operation from a host machine.

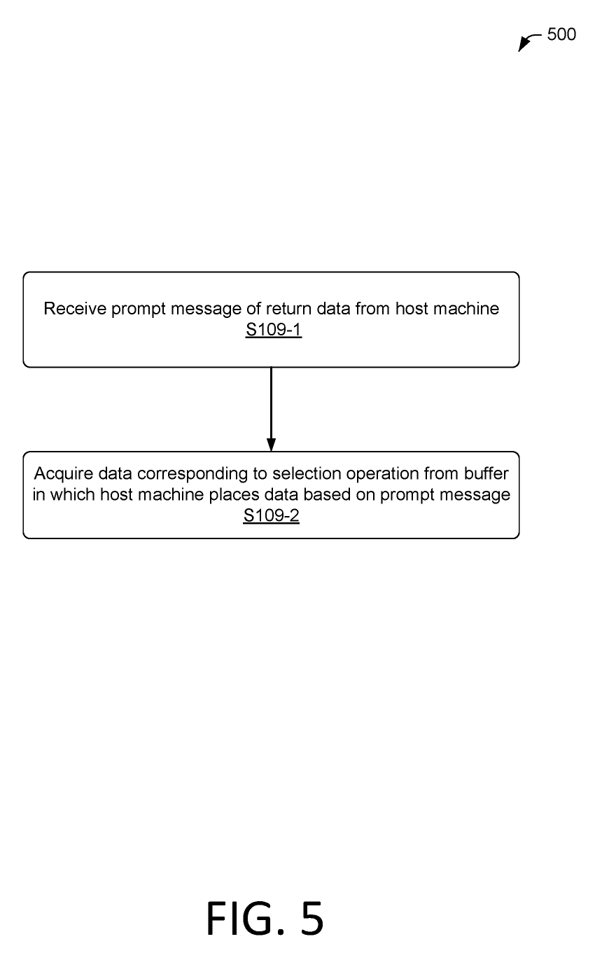

In implementations, the virtual machine may receive, from the host machine, a prompt message capable of reminding the virtual machine to receive the data prior to receiving the return data corresponding to the selection operation from the host machine. Detailed operations are provided in S109-1 to S109-2, as illustrated in FIG. 5.

FIG. 5 is a flowchart illustrating a process 500 of receiving return data corresponding to a selection operation from a host machine in accordance with the implementations of the present disclosure.

At S109-1, the virtual machine may receive a prompt message of the return data from the host machine.

At S109-2, the virtual machine may acquire the data corresponding to the selection operation from the buffer in which the host machine places the data based on the prompt message.

In implementations, the virtual machine may acquire the data corresponding to the selection operation from the buffer in which the host machine places the data based on the prompt message in the following manners. After receiving the prompt message of the return data from the host machine, the virtual machine may fish, in the buffer, data corresponding to the selection operation to achieve data exchange between the virtual machine and the host machine based on descriptions of the selection operation corresponding to the prompt message of the return data.

It should be noted that the data fished by the virtual machine from the host machine essentially is the data acquired by shared memory between the virtual machine and the host machine. The shared memory refers to a large amounts of memory accessible by various CPUs in multiprocessor computing systems. Since multiple CPU systems need to quickly access memory, the memory has to be cached. Shared memory is a communication method between multiple processes, and often used for a multi-program communication of a program. In fact, information can also be transmitted via shared memory between multiple programs. Shared memory controls data more conveniently as compared to other manners, and processes such as reading and writing of data are more transparent. After successful importing shared memory, the share memory is the equivalent of a string pointer to a block of memory to which a user can freely access in a current process. The disadvantages are provided as follow. In a data writing process or data reading process, a data structure control has to be added.

Implementations of the present disclosure also provide a method of acquiring data using a virtual machine. By receiving a selection operation of files shown in the directory information and receiving return data corresponding to the selection operation from a host machine, the virtual machine may acquire corresponding data based on demand without consuming additional traffic. To obtain a large file, the virtual machine does not need to download the whole file unnecessarily.

The above described implementations provide a method of acquiring data using a virtual machine. Corresponding to the method above, the present disclosure further relates to a device for acquiring data using a virtual machine. Since the device is substantially similar to the method described above, it is relatively simple description, which is merely illustrative.

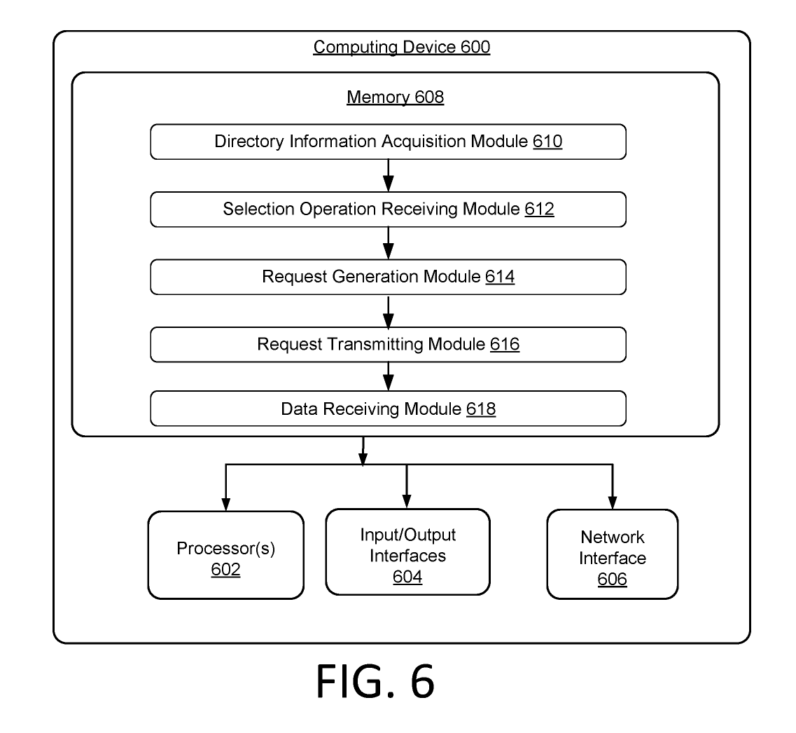

FIG. 6 is a schematic diagram illustrating a device 600 for acquiring data using a virtual machine in accordance with the implementations of the present disclosure.

The computing device 600 includes one or more processors 602, input/output interfaces 604, network interface 606, and memory 608.

The memory 608 may include computer-readable media in the form of volatile memory, such as random-access memory (RAM) and/or non-volatile memory, such as read only memory (ROM) or flash RAM. The memory 608 is an example of computer-readable media.

Computer-readable media includes volatile and non-volatile, removable and non-removable media implemented in any method or technology for storage of information such as computer readable instructions, data structures, program modules, or other data. Examples of computer storage media include, but are not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a device. As defined herein, computer-readable media does not include transitory media such as modulated data signals and carrier waves.

Turning to the memory 608 in more detail, the memory 608 may include a directory information acquisition module 610, a selection operation receiving module 612, a request generation module 614, a request transmitting module 616, and a data receiving module 618.

The directory information acquisition module 610 may be configured to acquire directory information of files that is stored in a cloud server. The selection operation receiving module 612 may be configured to receive a selection operation of the files that is shown in the directory information. The request generation module 614 may be configured to generate an acquisition request for data corresponding to the selection operation in the files. The request transmitting module 616 may be configured to place the acquisition request in a buffer. The data receiving module 618 may be configured to receive the return data corresponding to the selection operation from a host machine.

In implementations, the directory information acquisition module 610 include a file traversing submodule and a directory information display module. The file traversing submodule may be configured to traverse the files stored in the cloud server by the virtual machine. The directory information display module may be configured to create, in a predetermined path, the directory information that shows the files stored in the cloud server.

In implementations, the selection operation receiving module 612 include a first selection operation receiving submodule, a buffer submodule, and a selection operation receiving submodule. The first selection operation receiving submodule may be configured to receive a first selection operation of the files that is shown in the directory information. The buffer submodule may be configured to buffer files corresponding to the first selection operation. The selection operation receiving submodule may be configured to receive a selection operation of specific data shown in response to the buffering of the files.

In implementations, the request generation module 614 may be configured to generate the acquisition request for the data corresponding to the selection operation in the files based on the selection operation of the specific data shown after the buffering of the files.

In implementations, the acquisition request generated by the request generation module 614 may include a path of the files and a location corresponding to the data corresponding to the selection operation.

In implementations, the device 600 may further include a message sending module (not shown) configured to send a prompt message of the acquisition request to the host machine after the placing of the acquisition request in the buffer.

In implementations, the data receiving module 618 may include a prompt message judgment module configured to receive a prompt message of return data from the host machine, and a data acquisition submodule configured to acquire the data corresponding to the selection operation from the buffer in which the host machine places the data based on the prompt message.

In implementations, the device 600 may further include a device judging module (not shown) configured to determine whether the virtual machine is allocated with a virtual disk device prior to the acquiring the directory information of the files that is stored in the cloud server.

In implementations, the device 600 may further include a directory information acquisition triggering module (not shown) configured to receive a determining result from the device judging module. If the virtual machine is allocated with a virtual disk device, the directory information acquisition triggering module may trigger the directory information acquisition module.

In some implementations, the device 600 may further include an equipment allocation module (not shown) configured to receive a determining result from the device judging module. If the virtual machine is not allocated with a virtual disk device, the equipment allocation module may allocate the virtual disk device to the virtual machine.

In implementations, the allocated virtual disk device may include a virtual disk device on a bus of the virtual machine.

The above described implementations provide a method of acquiring data using a virtual machine and a device thereof. In addition, the implementations further relate to an electronic device.

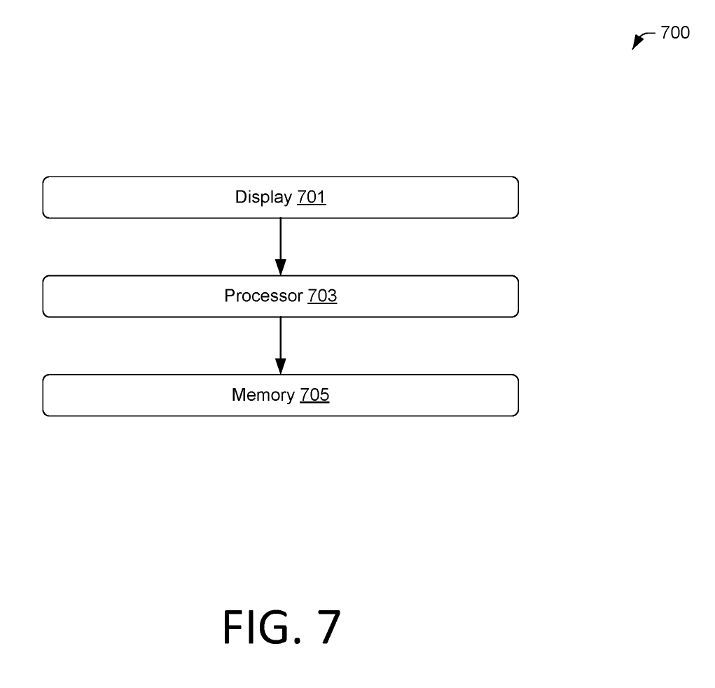

FIG. 7 is a schematic diagram illustrating an electronic device 700. The electronic device 700 may include a display 701, a processor 703, and a memory 705 configured to instructions to acquire data using a virtual machine, when the instructions are processed by the one or more processors, to perform the following operations. The operations may include acquiring directory information of files that is stored in a cloud server, receiving a selection operation of the files that is shown in the directory information, generating an acquisition request for data corresponding to the selection operation in the files, placing the acquisition request in a buffer, and receiving return data corresponding to the selection operation from a host machine.

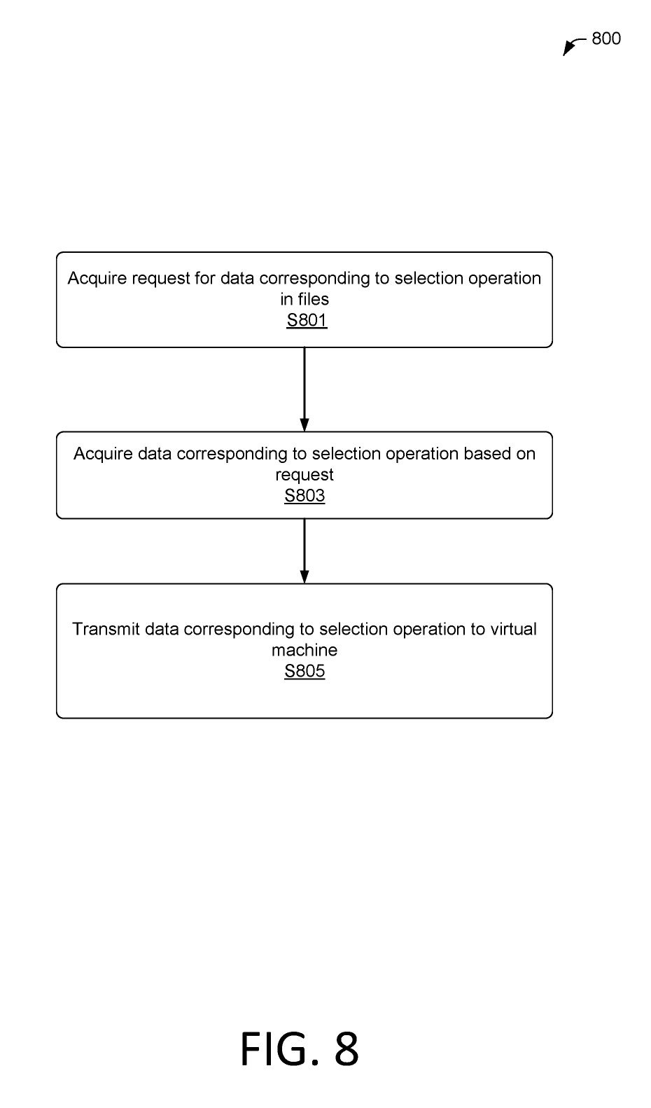

The above described implementations provide a method of acquiring data using a virtual machine as well as a device and an electronic device thereof. In addition, the present disclosure further relates to a method of acquiring data using a host machine, as illustrated in FIG. 8.

FIG. 8 is a flowchart illustrating a process 800 of acquiring data using a host machine in accordance with the implementations of the present disclosure. The method may include the following operations.

At S801, the host machine may acquire a request for data corresponding to a selection operation in files. The data is stored in a buffer by a virtual machine.

To enable the host machine to acquire data corresponding to the selection operation as fast as possible, the present disclosure provides some implementations. In some implementations, the host machine may receive a prompt message of the acquisition request from the virtual machine prior to acquiring the request for data that corresponds to the selection operation in files and is placed by the virtual machine in the buffer.

It should be noted that the prompt message of the acquisition request may include descriptions of the request of data corresponding to the selection operation of files and enable the host machine to acquire, from the buffer, the request of data corresponding to the selection operation to achieve data exchange between the virtual machine and the host machine.

In implementations, the host machine may be connected to servers of the OSS prior to acquiring the request for the data that corresponds to the selection operation in files and is placed by the virtual machine in the buffer. Detailed information of the connection is provided as follow.

The host machine may transmit a login request to the servers of the OSS. The login request may include account information of the host machine and login password.

The host machine may receive status information indicating the successful login, and establish a connection to the servers of the OSS.

In implementations, the host machine may acquire the request for data that corresponds to the selection operation in files and is placed by the virtual machine in the buffer in the following manners. After receiving the prompt message of the return data from the host machine, the host machine may determine and obtain the request of data corresponding to the selection operation of files based on descriptions of the request of data corresponding to the selection operation of files.

It should be noted that the request of data corresponding to the selection operation of files may include a path of the files and a location corresponding to the data corresponding to the selection operation. It is understood that the request of data corresponding to the selection operation of files may include path information of the object in the OSS corresponding to the selection operation and the location of the specific data of the object corresponding to the selection operation in the request.

At S803, the host machine may acquire the data corresponding to the selection operation based on the request.

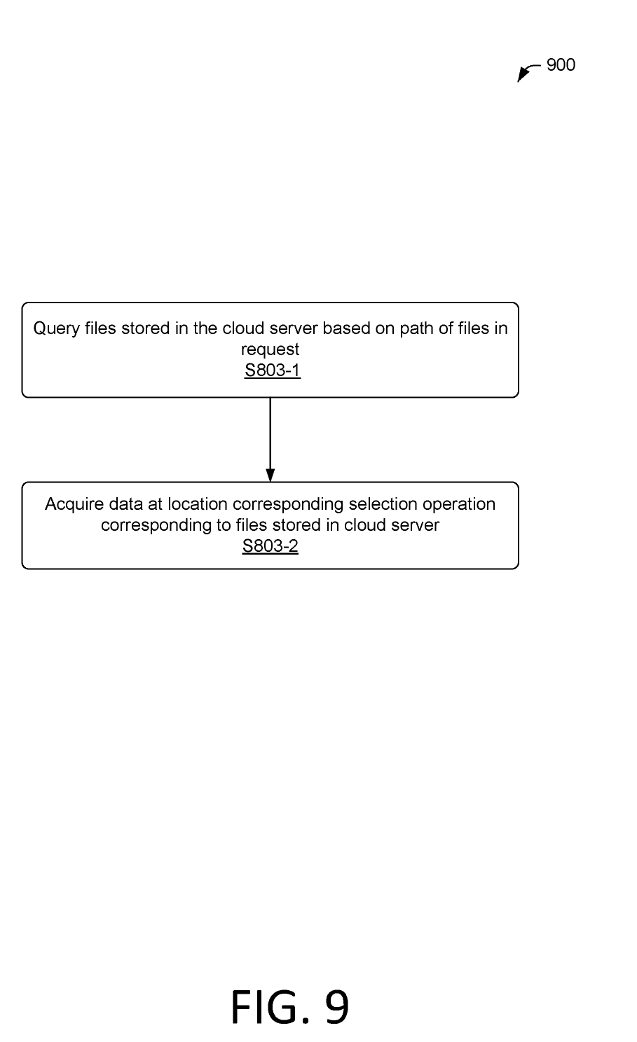

The host machine may access data of the object corresponding to the request in the servers of the OSS based on the request for data that corresponds to the selection operation in files, that is placed by the virtual machine in the buffer, and that is acquired at S801. The host machine may acquire the data corresponding to the selection operation based on the request by detailed operations described in S803-1 to 803-2, as illustrated in FIG. 9.

FIG. 9 is a flowchart illustrating a process 900 of acquiring the data corresponding to a selection operation based on the request in accordance with the implementations of the present disclosure.

At S803-1, the host machine may query the files stored in the cloud server based on the path of the files in the request.

In implementations, the host machine may query the files stored in the cloud server based on the path of the files in the request in the following manners. The host machine may extract the path of the files from the request for data that corresponds to the selection operation in files and is placed by the virtual machine in the buffer. The host machine may access the corresponding files on the servers of the OSS based on the path of the files. In other words, the host machine may access the corresponding object on the servers of the OSS based on the path of the files.

It should be noted that the host machine may call the responding interface of the OSS based on the path of the files in the request, and store the corresponding files on the servers of the OSS.

In implementations, the host machine may access the corresponding object on the servers of the OSS based on the path of the files by calling get_object (bucket_name, object_name) to access the corresponding files on the servers of the OSS. In these instances, bucket_name corresponds to the name of the bucket of the object stored in the path of the files, and object_name is the name of the object that corresponds to the path of the files and is stored on the server of the OSS.

At S803-2, the host machine may acquire data at a location corresponding the selection operation corresponding to the files stored in the cloud server.

In implementations, the host machine may acquire the data at the location corresponding the selection operation corresponding to the files stored in the cloud server in the following manners. The host machine may access the corresponding files stored on the servers of the OSS based on the path of the files in the request. Further, the host machine may extract the location of the data corresponding to the selection operation from the request for data that corresponds to the selection operation in files and is placed by the virtual machine in the buffer. The host machine may acquire the data of the object that is stored on the servers of the OSS and corresponds to the selection operation based on the location of the data.

For example, the object corresponding to the selection operation is a video file. The location of data corresponding to the selected operation is at 20-22 minutes of the video file. Accordingly, the host machine may acquire data of video clips between 20-22 minutes of the video files stored on the cloud server.

In implementations, the host machine may call a predetermined function of a cloud server to acquire data at a location corresponding the selection operation corresponding to the files stored in the cloud server. For example, to obtain 3 KB data in the file, the host machine may call:
headers [range]=“bytes=1024-4095”
get_object (bucket_name, object_name, headers).

At S805, the host machine may transmit the data corresponding to the selection operation to the virtual machine.

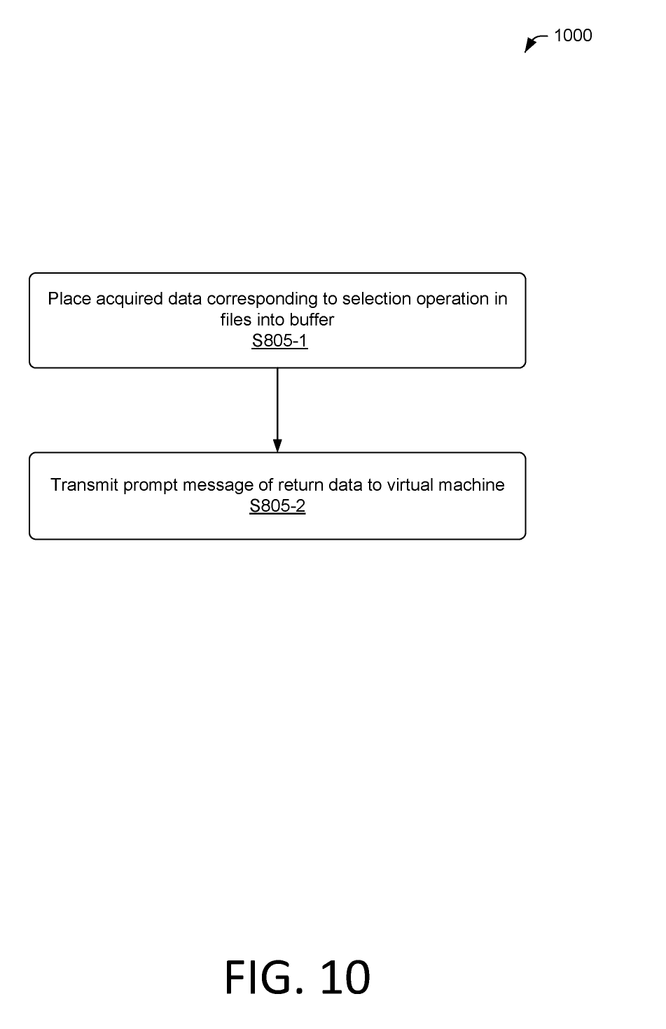

In implementations, the host machine may transmit the data corresponding to the selection operation to the virtual machine using detailed operations provided in S805-1 to S805-2, as illustrated in FIG. 10.

FIG. 10 is a flowchart illustrating a process 1000 of transmitting data corresponding to a selection operation to a virtual machine in accordance with the implementations of the present disclosure.

At S805-1, the host machine may place the acquired data corresponding to the selection operation in the files into a buffer.

The operation places, in the buffer, the request of data corresponding to the selection operation of files that is acquired at S803.

The buffer is an area for temporary storage of data in memory when a computer reads data, and is memory that temporarily stores output or input data. The data is sent to the CPU or other computing devices.

At S805-2, the host machine may transmit a prompt message of the return data to the virtual machine.

The host machine may place the acquired data corresponding to the selection operation in the files into a buffer, and then may transmit, to the virtual machine, a prompt message capable of reminding the virtual machine to receive the data. The virtual machine may fish, in the buffer, data corresponding to the selection operation based on descriptions of the selection operation corresponding to the prompt message of the return data.

The above described implementations provide a method of acquiring data using a host machine. Corresponding to the method above, the present disclosure further relates to a device for acquiring data using a host machine. Since the device is substantially similar to the method described above, it is relatively simple description, which is merely illustrative.

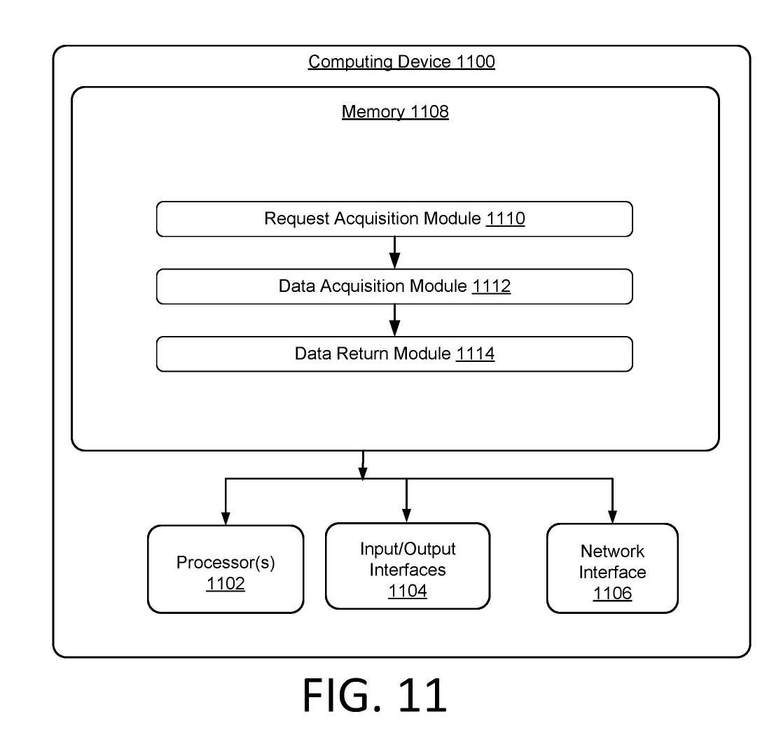

FIG. 11 is a schematic diagram illustrating a device 1100 for acquiring data using a host machine in accordance with the implementations of the present disclosure.

The computing device 1100 includes one or more processors 1102, input/output interfaces 1104, network interface 1106, and memory 1108.

The memory 1108 may include computer-readable media in the form of volatile memory, such as random-access memory (RAM) and/or non-volatile memory, such as read only memory (ROM) or flash RAM. The memory 1108 is an example of computer-readable media.

Turning to the memory 1108 in more detail, the memory 1108 may include a request acquisition module 1110, a data acquisition module 1112, and a data return module 1114.

The request acquisition module 1110 may be configured to acquiring a request for data corresponding to a selection operation in files. The data is stored in a buffer by a virtual machine. The data acquisition module 1112 may be configured to acquire the data corresponding to the selection operation based on the request. The data return module 1114 may be configured to transmit the data corresponding to the selection operation to the virtual machine,

In implementations, the memory 1108 may further include a prompt message judgment module (not shown) configured to receive a prompt message of the acquisition request from the virtual machine prior to acquiring the request for the data that corresponds to the selection operation in files and is placed by the virtual machine in the buffer.

In implementations, the memory 1108 may further include a connection establishing module (not shown) configured to establish a connection based on account information of a user with the cloud server prior to acquiring the request for the data that corresponds to the selection operation in files and is placed by the virtual machine in the buffer.

In implementations, the request acquisition module 1110 may be configured to acquire the request for data corresponding to the selection operation in files. The data is stored in a buffer by a virtual machine, and the request may include a path of the files and a location corresponding to the data corresponding to the selection operation.

In implementations, the data acquisition module 1112 may include a file query submodule and a data acquiring submodule (both not shown).

The file query submodule may be configured to query the files stored in the cloud server based on the path of the files in the request.

The data acquisition module may be configured to acquire data at a location corresponding the selection operation corresponding to the files stored in the cloud server.

In implementations, the data acquisition module 1112 may be configured to call a predetermined function of a cloud server, and acquire data at a location corresponding the selection operation corresponding to the files stored in the cloud server.

In implementations, the data return module 1105 may include a data return submodule (not shown) configured to place the acquired data corresponding to the selection operation in the files into a buffer, and a prompt message sending submodule configured to transmit a prompt message of the acquisition request to the virtual machine.

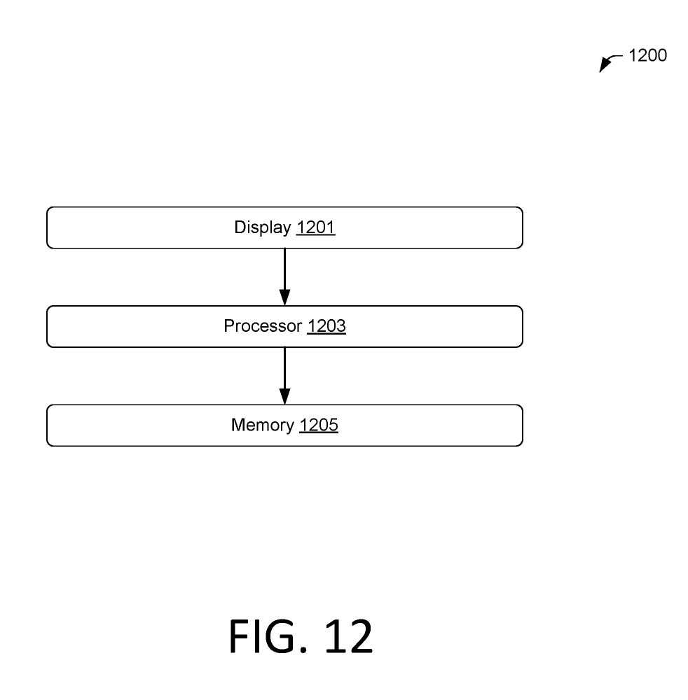

As described in the above described implementations, the present disclosure further relates to a device for acquiring data using a virtual machine, and an electronic device thereof as well as a device for acquiring data using a host machine, and an electronic device thereof. In addition, the implementations further relate to an electronic device, as illustrated in FIG. 12.

FIG. 12 is a schematic diagram illustrating an electronic device 1200, which may include a display 1201, a processor 1203, memory 1205 configured to store instructions to acquire data using a host machine. The instructions are processed by the one or more processors to perform the following operations. The operations may include acquiring a request for data corresponding to a selection operation in files, and transmit the data corresponding to the selection operation to the virtual machine based on the request, acquiring the data corresponding to the selection operation. The data is stored in a buffer by a virtual machine.

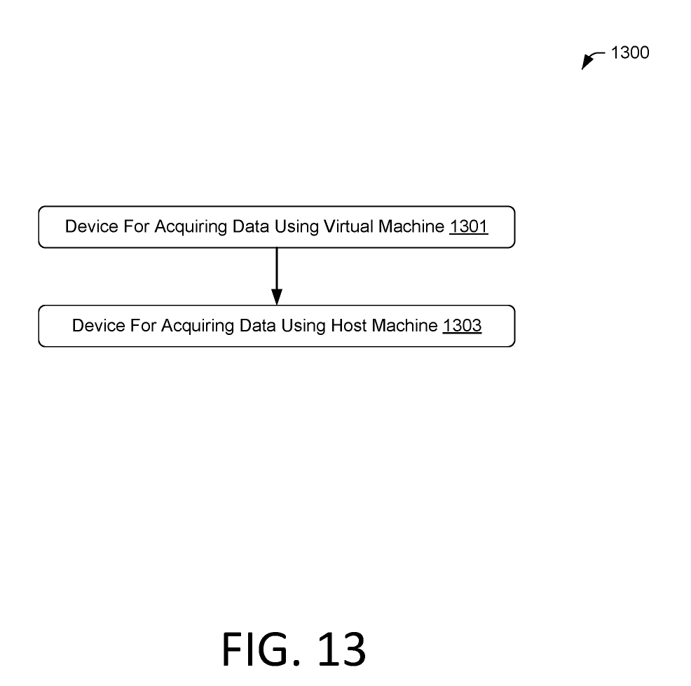

As illustrated in the above described implementations, the present disclosure relates to a device for acquiring data using a virtual machine, and an electronic device thereof as well as a device for acquiring data using a host machine, and an electronic device thereof. In addition, the present disclosure further relates to a system for accessing cloud data using a virtual machine, as illustrated in FIG. 13.

FIG. 13 is a schematic diagram illustrating a system 1300 for accessing cloud data using a virtual machine in accordance with the implementations of the present disclosure.

The system 1300 for accessing cloud data using the virtual machine may include a device for acquiring data using a virtual machine 1301 and a device for acquiring data using a host machine 1303.

The device 1301 may be configured to acquire directory information of files that is stored in a cloud server, receive a selection operation of the files that is shown in the directory information, generate an acquisition request for data corresponding to the selection operation in the files, and receive the return data corresponding to the selection operation from the host machine.

The device 1303 may be configured to acquire a request for data corresponding to a selection operation in files, acquire the data corresponding to the selection operation based on the request, and transmit the data corresponding to the selection operation to the virtual machine. The data is stored in a buffer by a virtual machine

In a typical configuration, a computing device includes one or more processors (CPU), input/output interfaces, network interfaces, and memory.

Memory may include computer-readable medium volatile memory, random access memory (RAM) and/or nonvolatile memory, etc., such as read only memory (ROM) or flash memory (flash RAM). Computer-readable memory medium are examples.
1. A computer-readable media includes permanent and non-permanent, removable and non-removable media may be made in any method or technology to achieve information storage. Information may include computer-readable instructions, data structures, program modules or other data. Examples of computer storage media include, but not limited to phase-change memory (PRAM), static random access memory (SRAM), dynamic random access memory (DRAM), other types of random access memory (RAM), read only memory (ROM), electrically erasable programmable Read Only memory (EEPROM), flash memory or other memory technology, CD-ROM read-only memory (CD-ROM), digital versatile disc (DVD) or other optical storage, magnetic cassettes, magnetic disk storage or other magnetic tape storage devices, or any other magnetic non-transmission medium, which can be used to store the information for access by computing devices. Defined in accordance with this present disclosure, computer-readable media does not include non-transitory media, such as modulated data signal and carriers.
2. One skilled in the art should understand, implementations of the present disclosure provide a method, system, or computer program product. Accordingly, the present disclosure may be entirely implemented by hardware, software, or a combination of hardware and software. Further, the present disclosure can be used in one or more computer usable storage media (including but not limited to the optical disk storage and memory, etc.) that contain computer usable program codes and are implemented on a computer program product.

Although the present disclosure provides preferred implementations above, it is not intended to limit the present disclosure, one of ordinary skill in the art, without departing from the spirit and scope of the present disclosure, may make possible changes and modifications. Therefore, the scope of application should be defined by the scope of the claims of the present disclosure.

What is claimed is:

1. A method of acquiring data using a virtual machine, the method comprising:
acquiring, by one or more processors of a computing device, directory information of files that is stored in a cloud server;
receiving, by the one or more processors, a selection operation of the files that is shown in the directory information;
generating, by the one or more processors, an acquisition request for data corresponding to the selection operation in the files;
placing, by the one or more processors, the acquisition request in a buffer; and
receiving, by the one or more processors, return data corresponding to the selection operation from a host machine.

2. The method of claim 1, wherein the acquiring the directory information of the files that is stored in the cloud server comprises:
traversing the files stored in the cloud server by the virtual machine; and
creating, in a predetermined path, the directory information that shows the files stored in the cloud server.

3. The method of claim 1, wherein the receiving the selection operation of the files that is shown in the directory information comprises:
receiving a first selection operation of the files that is shown in the directory information;
buffering files corresponding to the first selection operation; and
receiving a selection operation of specific data that is shown after the buffering of the files.

4. The method of claim 3, wherein the generating the acquisition request for the data corresponding to the selection operation in the files comprises generating the acquisition request for the data corresponding to the selection operation in the files based on the selection operation of the specific data that is shown after the buffering of the files.

5. The method of claim 4, wherein the acquisition request comprises a path of the files and a location corresponding to the data corresponding to the selection operation.

6. The method of claim 1, further comprising:
sending a prompt message of the acquisition request to the host machine after the placing of the acquisition request in the buffer.

7. The method of claim 1, wherein the receiving the return data corresponding to the selection operation from the host machine comprises:
receiving a prompt message of the return data from the host machine; and
acquiring the data corresponding to the selection operation from the buffer in which the host machine places the data based on the prompt message.

8. The method of claim 1, further comprising:
prior to the acquiring of the directory information of the files that is stored in the cloud server,
determining whether the virtual machine is allocated with a virtual disk device;
in response to a determination that the virtual machine is allocated with a virtual disk device, acquiring the directory information of the files that is stored in the cloud server.

9. The method of claim 1, further comprising:
prior to the acquiring of the directory information of the files that is stored in the cloud server,
determining whether the virtual machine is allocated with a virtual disk device;
in response to a determination that the virtual machine is not allocated with a virtual disk device, allocating the virtual disk device to the virtual machine.

10. The method of claim 9, wherein the allocated virtual disk device comprises a virtual disk device on a bus of the virtual machine.

11. An electronic device, wherein the electronic device comprising:
one or more processors; and
memory configured to store instructions to acquire data using a virtual machine, when the instructions are processed by the one or more processors, to perform acts comprising:
acquiring directory information of files that is stored in a cloud server,
receiving a selection operation of the files that is shown in the directory information,
generating an acquisition request for data corresponding to the selection operation in the files,
placing the acquisition request in a buffer, and
receiving return data corresponding to the selection operation from a host machine.

12. The electronic device of claim 11, wherein the acquiring the directory information of the files that is stored in the cloud server comprises:
traversing the files stored in the cloud server by the virtual machine; and
creating, in a predetermined path, the directory information that shows the files stored in the cloud server.

13. The electronic device of claim 11, wherein the receiving the selection operation of the files that is shown in the directory information comprises:
receiving a first selection operation of the files that is shown in the directory information;
buffering files corresponding to the first selection operation; and
receiving a selection operation of specific data that is shown after the buffering of the files.

14. A method of acquiring data using a host machine, the method comprising:
acquiring, by one or more processors of a computing device, a request for data corresponding to a selection operation in files, the data stored in a buffer by a virtual machine;
acquiring, by the one or more processors, the data corresponding to the selection operation based on the request; and
transmitting, by the one or more processors, the data corresponding to the selection operation to the virtual machine.

15. The method of claim 14, further comprising:
receiving a prompt message of the request from the virtual machine prior to the acquiring of the request for the data that corresponds to the selection operation in files and is placed by the virtual machine in the buffer.

16. The method of claim 14, further comprising:
establishing a connection based on account information of a user with a cloud server prior to the acquiring of the request for the data that corresponds to the selection operation in files and is placed by the virtual machine in the buffer.

17. The method of claim 14, wherein the request comprises a path of the files and a location corresponding to the data corresponding to the selection operation.

18. The method of claim 17, wherein the acquiring the data corresponding to the selection operation based on the request comprises:
querying the files stored in a cloud server based on the path of the files in the request; and
acquiring data at a location corresponding the selection operation corresponding to the files stored in the cloud server.

19. The method of claim 18, wherein the acquiring the data at the location corresponding the selection operation corresponding to the files stored in the cloud server comprises:
calling a predetermined function of a cloud server; and
acquiring data at a location corresponding the selection operation corresponding to the files stored in the cloud server.

20. The method of claim 14, wherein the transmitting the data corresponding to the selection operation to the virtual machine comprises:
placing the acquired data corresponding to the selection operation in the files into a buffer; and
transmitting a prompt message of return data to the virtual machine.
